(19) United States
(12) Patent Application Publication
(10) Pub. No.: US 2025/0134066 A1
(43) Pub. Date: May 1, 2025

(54) IMPROVED EQUINE BOOT AND METHOD

(71) Applicant: EasyCare, Inc., Durango, CO (US)

(72) Inventor: Garrett Ford, Durango, CO (US)

(73) Assignee: EasyCare, Inc., Durango, CO (US)

(21) Appl. No.: 18/927,236

(22) Filed: Oct. 25, 2024

Related U.S. Application Data
(60) Provisional application No. 63/545,675, filed on Oct. 25, 2023.
(60) Provisional application No. 63/635,830, filed on Apr. 18, 2024.

(51) Int. Cl. A01K 13/00

(52) U.S. Cl. CPC A01K 13/007

(57) ABSTRACT

An equine boot including a multi-density polymer shoe.

### CROSS-REFERENCE TO RELATED APPLICATIONS

This application claims the priority benefit of U.S. Provisional Application No. 63/545,675, filed Oct. 25, 2023 and U.S. Provisional Application No. 63/635,830, filed Apr. 18, 2024, both of which are incorporated herein by reference in their entirety.

### FIELD OF THE DISCLOSURE

This patent application relates to equine boots with improved fitment and durability.

### BACKGROUND

In recent decades, the equine industry has developed a number of boots for equine wear during performance riding. These boots share a number of common components. These include a bottom, a gaiter and a belt that secures the boot to a horse's foot. However, hoof anatomy creates unique and complicated challenges regarding fit and wear of hoof boots. Among other things, the hoof wall, frog and digital cushion all raise uniquely different function and fit challenges. For example, components above the horse coronet (i.e., the hairline) must be soft and pliable, whereas the frog requires far more robust protection and support while maintaining appropriate flexibility. As a result, it is crucial that boots provide proper functionality and fit for the unique anatomy of horse hooves. Moreover, as the performance requirements of a horse and rider increase, the requirements for specialized functionality, fit, durability, low weight, protection and support increase significantly.

To address such challenges, existing hoof boots employ complex gaiter systems, as depicted in FIGS. 1 and 2. More specifically, FIG. 1 illustrates an existing gaiter system 1 in which a gaiter 3 is mechanically attached to a shoe 4 using a strap 3 with screws 5 or bolts and washers. In turn, a thick, upper is sewn into the strap. The upper itself is made of a number of components, including a complicated, multi-layer arrangement of thick canvas and neoprene. Such components are sewed together using a myriad of stitch types and thicknesses spanning a complex network of stitching through different portions of the neoprene and canvas. Alternatively, as shown in FIG. 2, other gaiter systems employ plastic connectors, screws, washers and adhesives to attach a rubber upper to the lower. Another existing hoof boot system is disclosed in U.S. Pat. No. 7,578,115 (the “'115 patent”), which is incorporated by reference herein. As shown in FIGS. 2, 6 and 7 of the '115 patent, the boot includes a prior art shell having strips secured to the shell using rivets, screws, bolts, clamps or other semi-permanent, mechanical fastening mechanisms. Prior art systems have also disclosed tensioning systems to attach a shell to the horse hoof, as described in the '115 patent, cols. 7-8.

While the existing hoof boots defined by this general description provide advantages over traditional horse shoe designs, they all suffer from a number of persistent and performance-limiting drawbacks. For example, the number of stitches, seams and interworking parts associated with such hoof boots increases the risk of areas prone to premature wear, incorrect fit, or failure. Indeed, in some circumstances, wear or breakage of certain hoof boot components often requires replacement of the entire hoof boot, even as most or many of the parts have extensive remaining useful life. Moreover, current hoof boot are cumbersome, difficult to position when putting them on a horse, and add excess weight.

Further, existing hoof boots are exceedingly expensive to manufacture. Indeed, manufacture of current hoofs boot requires multiple skillsets and machines for manufacture of various components; and substantial time and costly labor in connection with assembly, including labor that can reliable cut and sew complex patterns on thick and unruly materials. Further still, the complexity and performance requirements of such products leads to significant amounts of material and labor loss as a result of manufacturing mistakes. Even further still, the number of different parts required to create hoof boots of different sizes adds to the cost of manufacture.

What is needed, therefore, is an equine shoe that improves upon or resolves one or more of these drawbacks.

### SUMMARY

This application discloses a multi-density hoof boot. In one preferred embodiment, the hoof boot includes an integrated and substantially seamless support boot. In another preferred embodiment, the hoof boot includes a replaceable gaiter.

### BRIEF DESCRIPTION OF DRAWINGS

Embodiments of the application will be described in detail in conjunction with FIGS. 3-30.

FIGS. 1 and 2 show existing hoof boots according to the prior art.

FIG. 3 is a perspective view of a hoof boot according to the disclosure.

FIG. 4 is a partial side view of a hoof boot according to the disclosure.

FIG. 5 is a rear view of a hoof boot according to the disclosure.

FIG. 6 is a perspective side view of a hoof boot according to the disclosure.

FIG. 7 is a left side view of a hoof boot according to the disclosure.

FIG. 8 is a perspective side view of a hoof boot according to the disclosure.

FIG. 9 is a perspective top view of a hoof boot according to the disclosure.

FIG. 10 is a perspective top view of a hoof boot according to the disclosure.

FIG. 11 is a perspective top view of a hoof boot according to the disclosure.

FIG. 12 is a right side view of a hoof boot according to the disclosure.

FIG. 13 is a perspective side view of a hoof boot according to the disclosure having an everted heel cup.

FIG. 14 is a perspective side view of a hoof boot according to the disclosure having a heel support.

FIG. 15 is a perspective side view of a hoof boot according to the disclosure having a heel support.

FIG. 16 is a perspective side view of a hoof boot according to the disclosure.

FIG. 17 is a perspective rear view of a hoof boot according to the disclosure.

FIG. 18 is a perspective rear view of a hoof boot according to the disclosure.

FIG. 19 is a perspective rear view of a hoof boot according to the disclosure.

FIG. 20 is a perspective rear view of a hoof boot according to the disclosure.

FIG. 21 is a perspective bottom view of a hoof boot according to the disclosure.

FIG. 22 is a rear view of a gaiter according to the disclosure.

FIG. 23 is a perspective rear view of a gaiter according to the disclosure.

FIG. 24 is a perspective rear view of a gaiter according to the disclosure.

FIG. 25 is a perspective side view of a gaiter according to the disclosure.

FIG. 26 is a front view of a gaiter according to the disclosure.

FIG. 27 is a perspective front view of the hoof boot with a gaiter according to the disclosure.

FIG. 28 is a perspective front view of the hoof boot with a gaiter according to the disclosure.

FIG. 29 is a perspective side view of the hoof boot with a gaiter according to the disclosure.

FIG. 30 is a perspective side view of the hoof boot with a gaiter according to the disclosure.

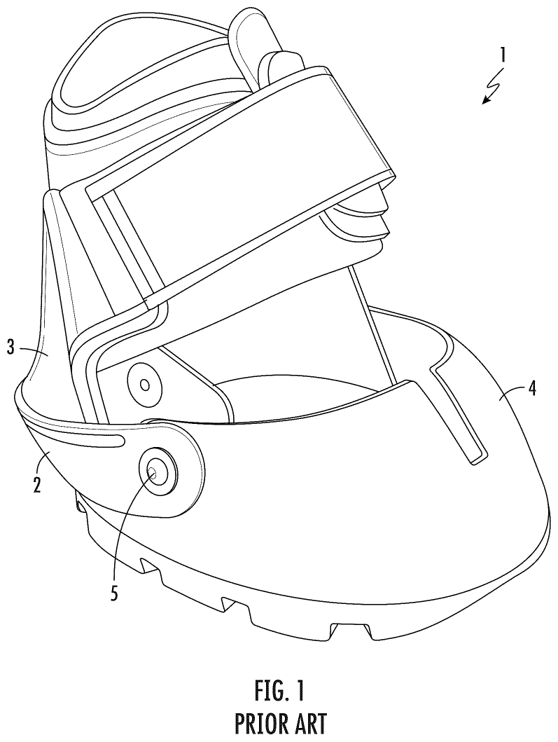

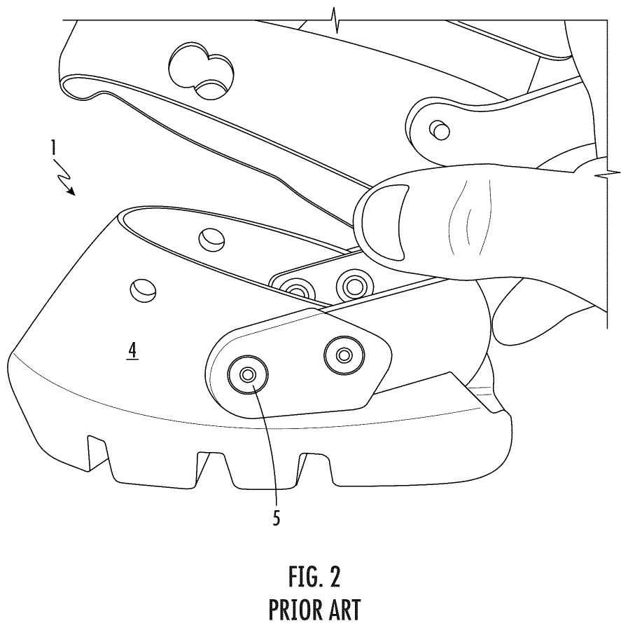

### DETAILED DESCRIPTION

Other features and advantages of this disclosure will become apparent in the following detailed description of the embodiment(s) with reference to the accompanying drawings.

To aid in describing the disclosure, directional terms may be used in the specification and claims to describe portions of the present disclosure (e.g., front, rear, left, right, top, bottom, proximal, distal, superior, inferior, etc.). These directional definitions are intended to merely assist in describing and claiming the disclosure and are not intended to limit the disclosure in any way.

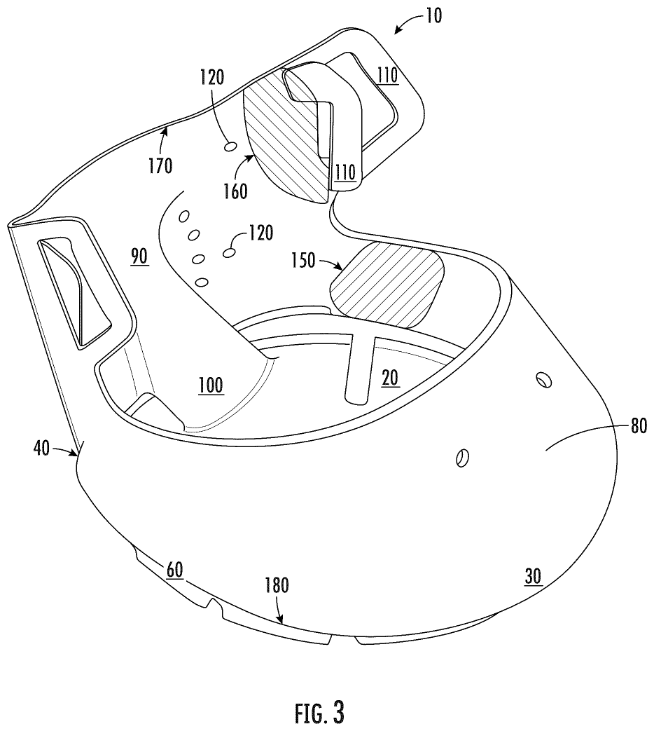

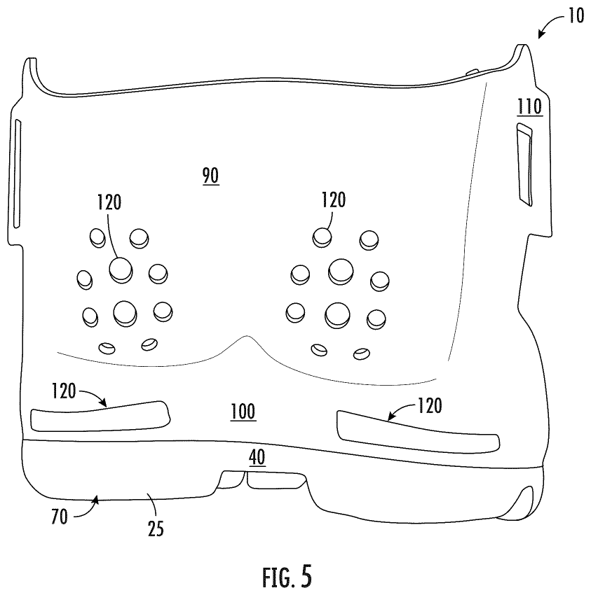

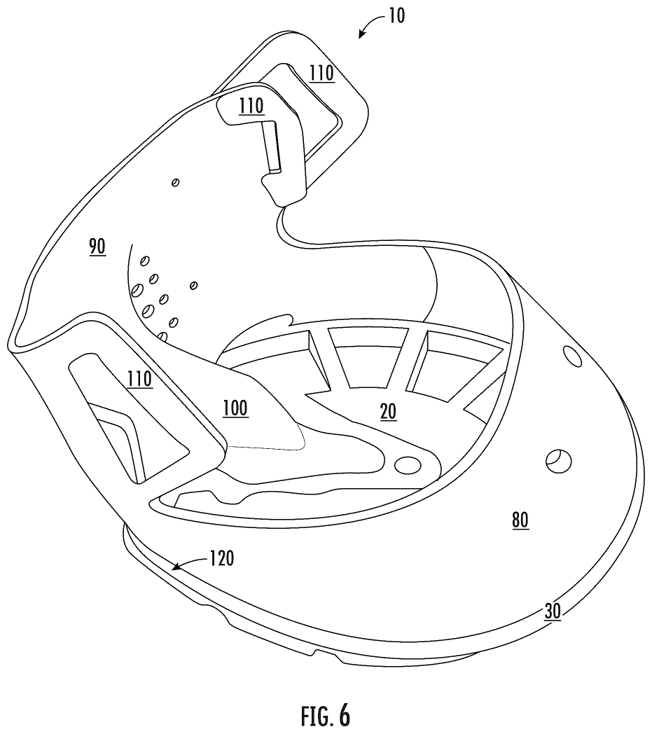

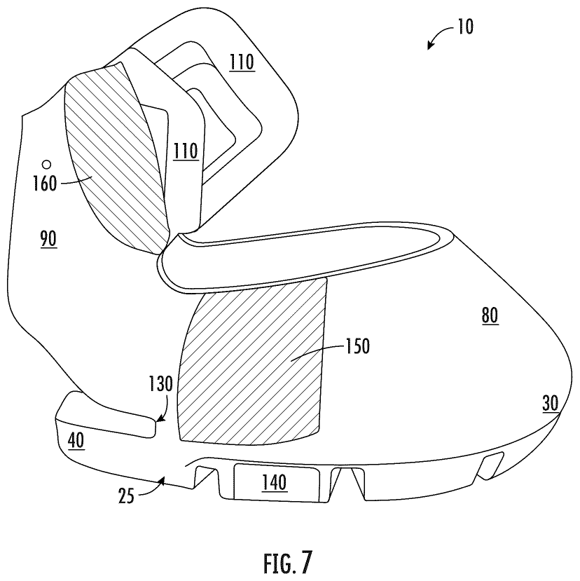

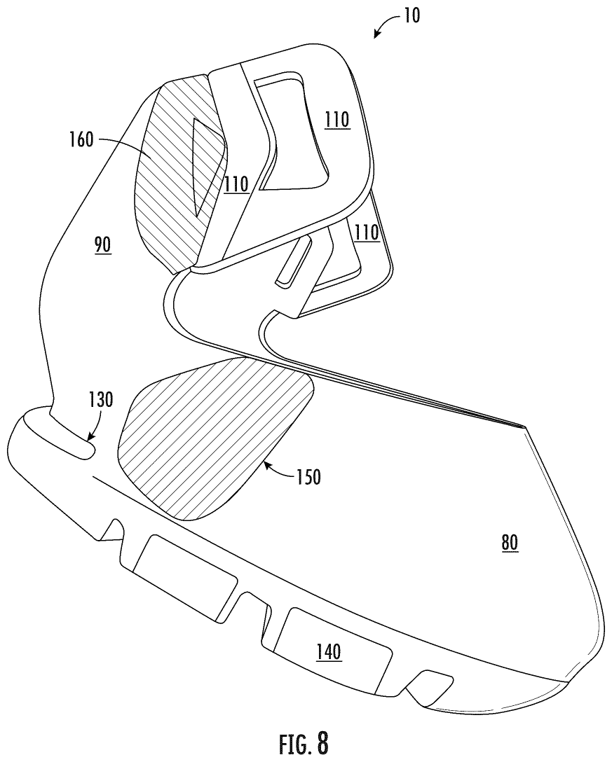

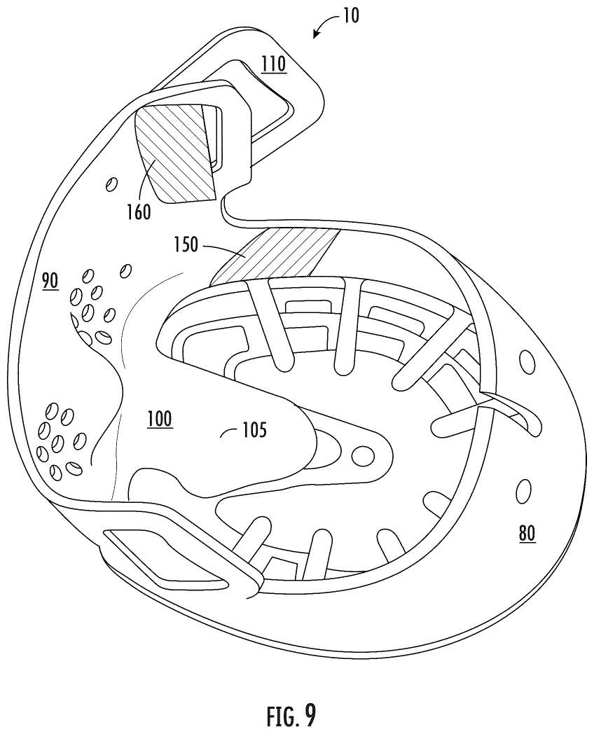

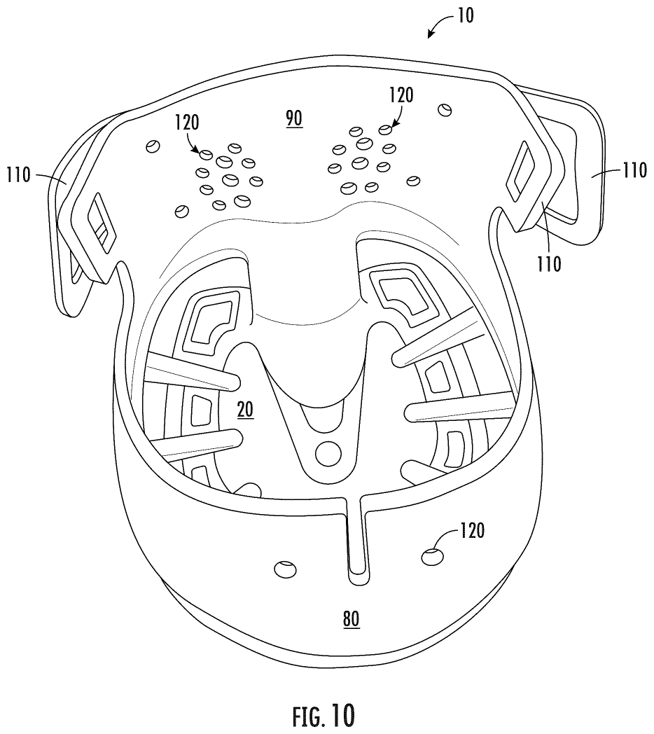

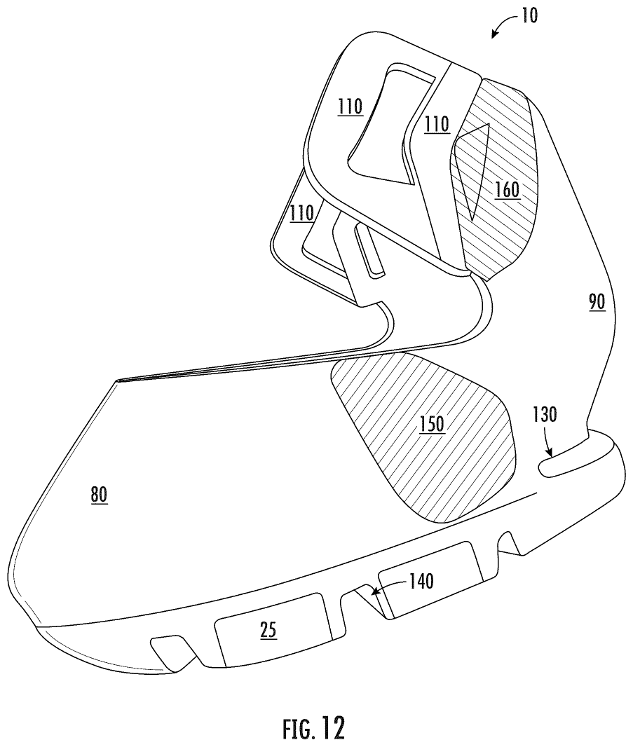

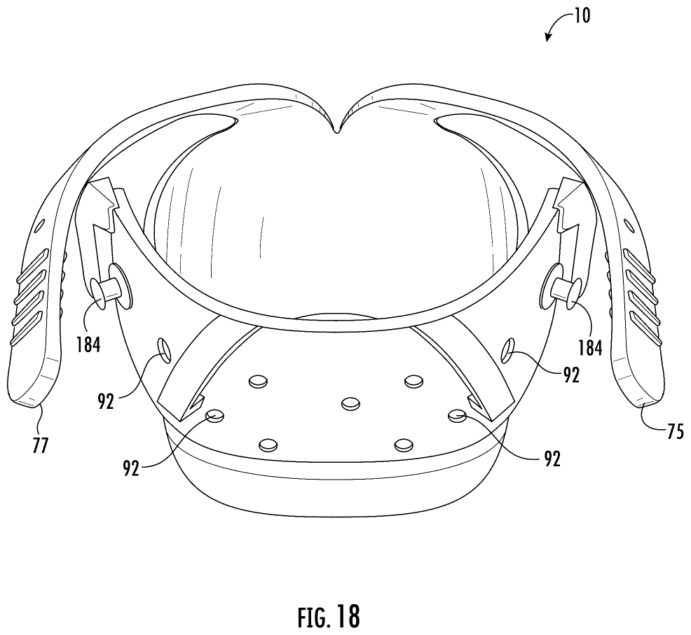

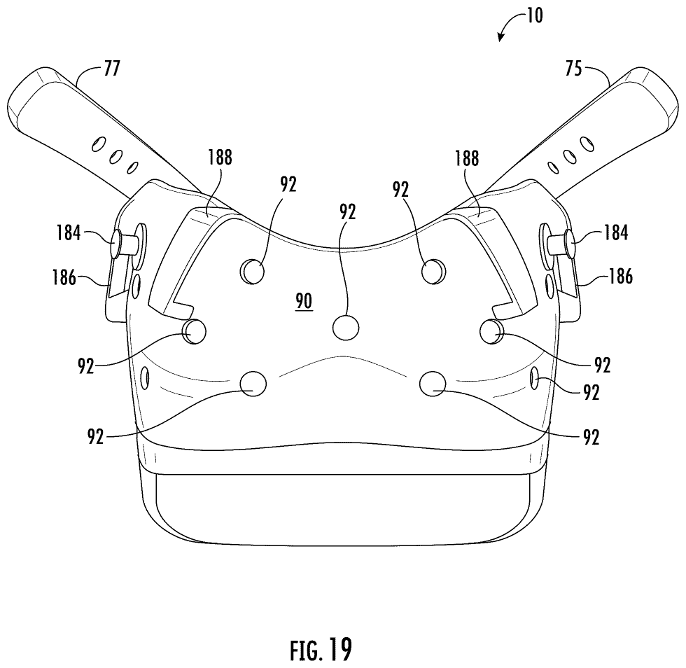

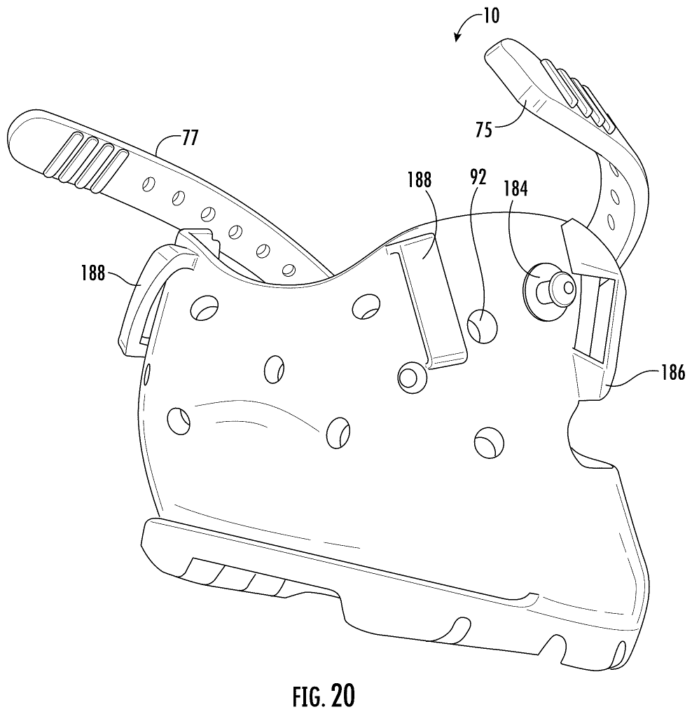

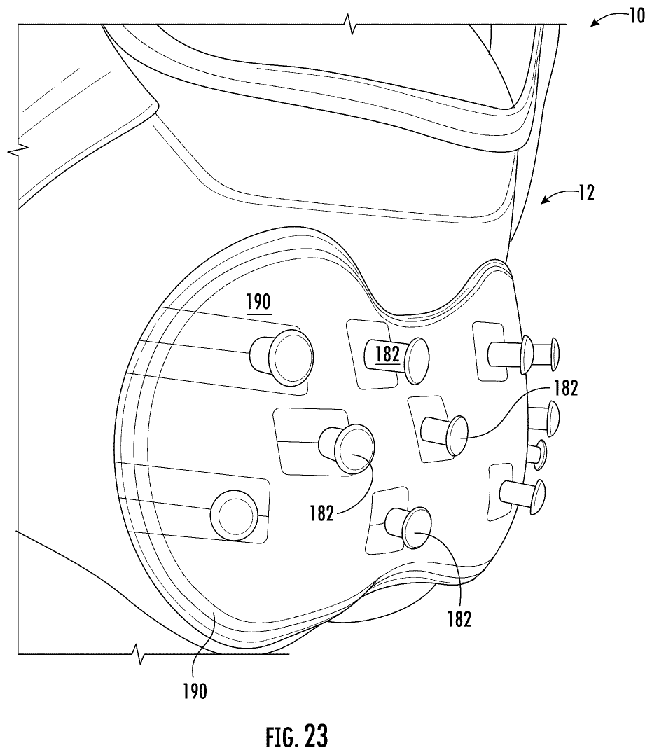

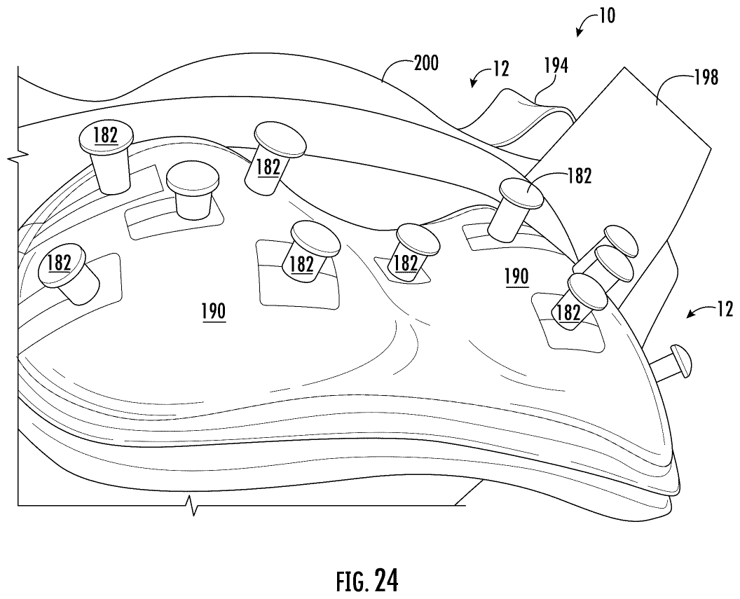

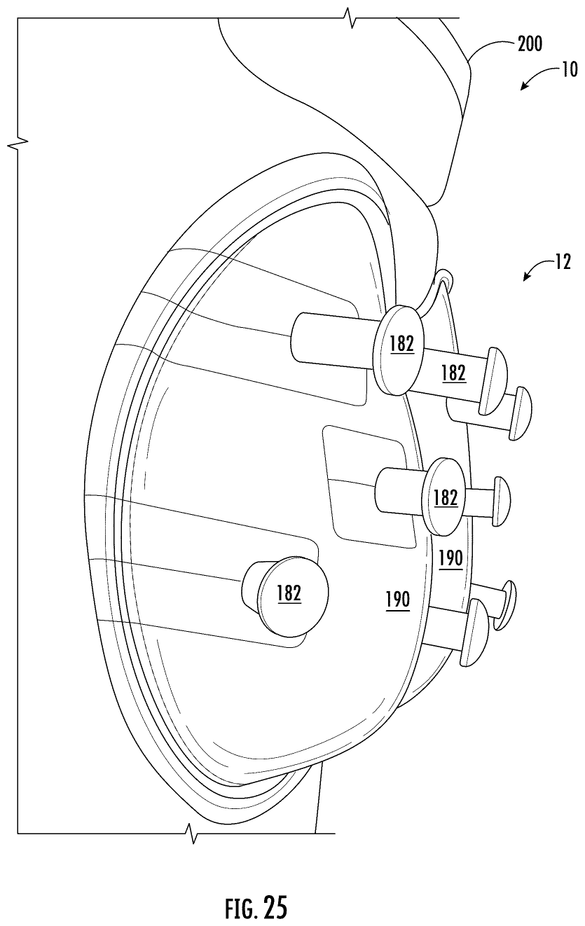

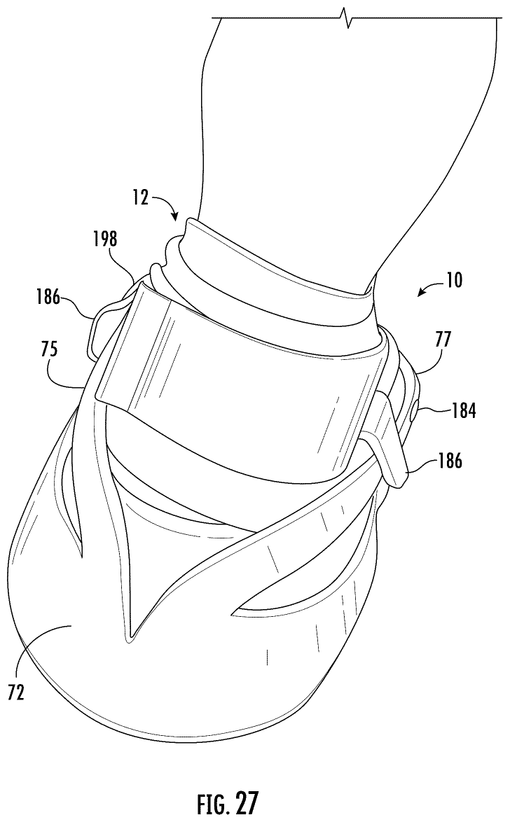

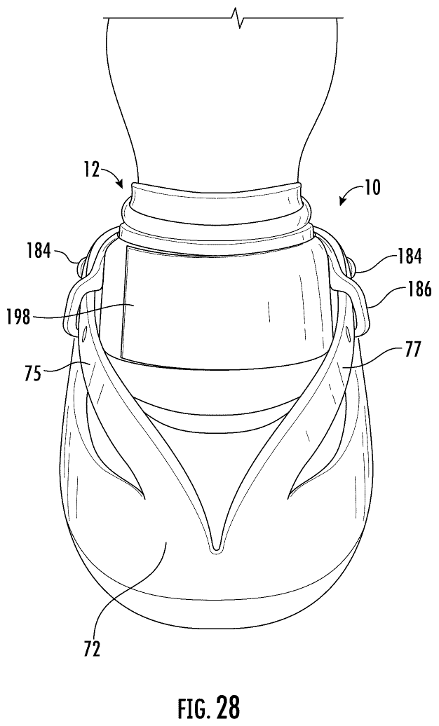

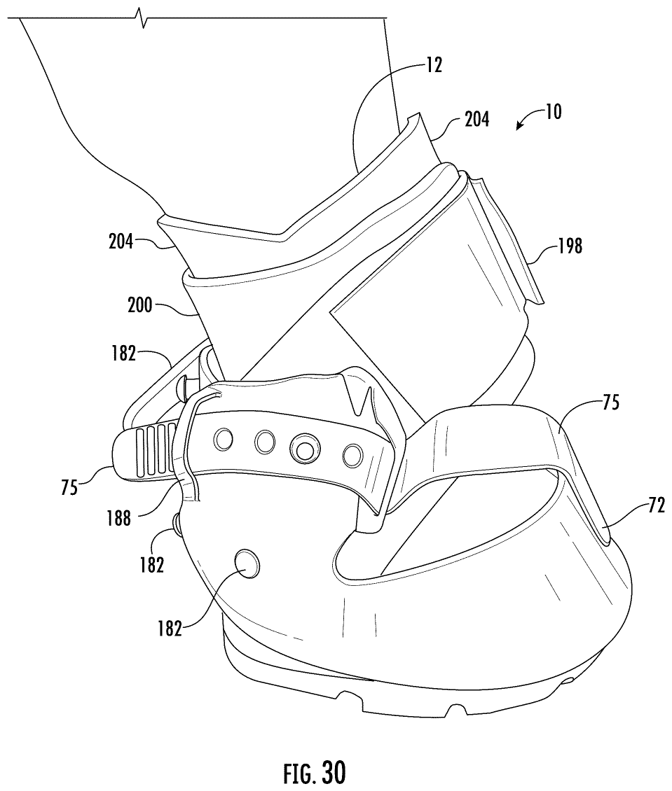

Embodiments of the present disclosure are best understood by referring to FIGS. 3-30 of the drawings, like numerals being used for like and corresponding parts of the various drawings.

### LIST OF REFERENCES

10 Boot
12 Gaiter
20 Horse Sole Bed
25 Sole
30 Distal End
40 Proximal End
60 Lateral Wall
70 Jacket or Shell
72 Weld
75 Belt or Strap
77 Belt
79 Harness
80 Wall
90 Heel or Heel Segment
92 Hole
94 Support
96 Screw
98 Inserts or Pegs
100 Tongue
105 Tongue Weld
110 Frame
120 Fenestration
130 Carveout
140 Treads
150 Lower Transition Region
160 Upper Transition Region
170 Superior end
180 Inferior end
182 Peg
185 Hole
184 Catch
186 Distal Slide
188 Proximal Slide
190 Heel Cup or Heel Segment Fastener
194 Pastern Strap
198 Pastern Fastener
200 Wrap
204 Lining

As used herein, the term “horse boot” or “hoof boot” is intended to refer to a hoof-wear article that wraps substantially around the hoof of the horse and may or may not include a gaiter or more simple support that can be attached to the pastern. The term “horse shoe” is used to describe a lower profile item, without a gaiter, that may wrap only partially around the hoof of the horse. The term “sole” is defined to refer only to that part of a horse boot or shoe that covers a substantial portion of the underside of the hoof. By contrast, the term “horseshoe” is defined to refer to a structure, made of any material, that is substantially in the form of a conventional iron horseshoe that has an open heel and an interior open area corresponding substantially to the interior underside of the hoof of the horse. As described with reference to the present invention, the heel segment or portions of the heel may be connected by a bridging structure. Finally, the terms “supple” and “resilient” is used in this specification to mean capable of deforming when subjected to a bending, compressing or stretching force and of returning to the original condition when such force is released. In view of the fact that most materials exhibit some degree of resilience, for the purposes of this disclosure and of the claimed invention the term resilient is limited to materials that can be bent by at least 30 degrees without suffering any permanent deformation.

In general, as depicted in FIGS. 3-15, boot 10 has a rigid horse sole bed 20, a wall 80, a supple or resilient heel segment 90, a proximal end 40, a distal end 30, a superior end 170 and an inferior end 180. Heel segment 90 is connected to wall 80 by way of a lower transition region 150. Further, the superior end 170 of heel segment 90 includes an upper transition region that is seamlessly connected to a frame 110. The boot inferior end 180 provides a sole 25 having treads 140. Further, boot 10 includes a jacket 70 with belts 75. Additionally, belts 75 and 77 extend from tongue 100.

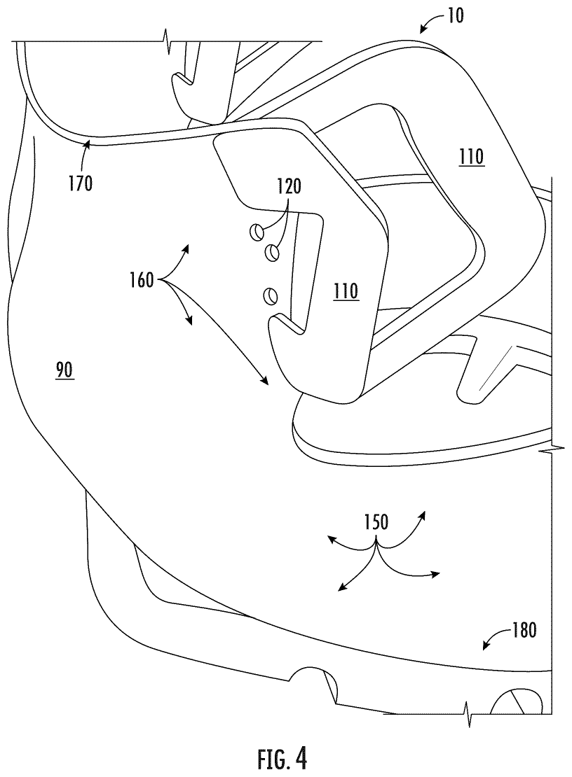

Referring to FIG. 3, boot 10 includes three primary sections, all of which are formed integrally and seamlessly. Wall 80 and sole 25 form a rigid polymer shoe that, together, constitute the first section. Preferably, the shoe is formed from a urethane having a durometer between 80A and 90A. Heel segment 90 and tongue 100, together, constitute the second section. The heel and tongue are made of a much more resilient or supple urethane material having a durometer between 55A and 70A. Lastly, frames 110 constitute the third section. Frames 110 are made of a urethane having a durometer between 80A and 90A. As shown in FIGS. 4 and 7-9, the three sections of boot 10 are overmolded together, thus forming an integral and seamless boot unit.

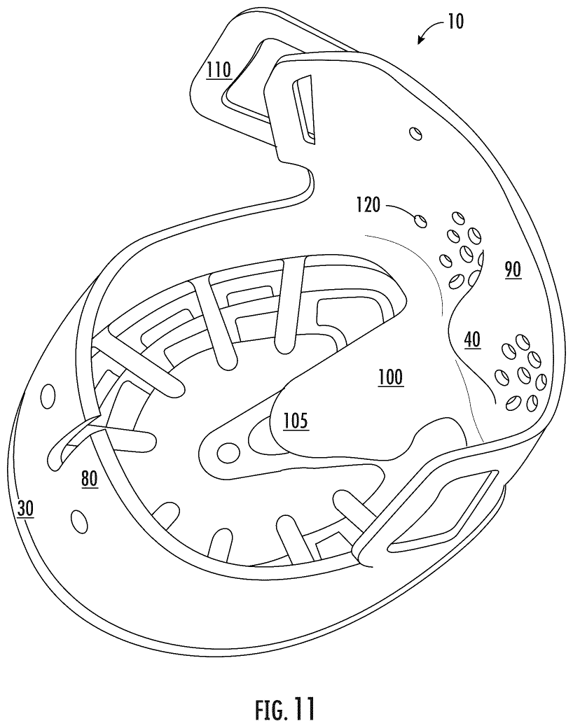

Referring to FIG. 11, heel segment 90 is provided with a plurality of fenestrations 120. Fenestrations 120 facilitate expansion and contraction of heel segment 90 to accommodate expansion/contraction of a horse digital cushion during movement. Additionally, fenestrations 120 improve breathability and water drainage in hot or web conditions, respectively. Tongue 100, which is overmolded onto sole bed 20, improves hoof retention and positioning within boot 10. A tongue that extends the entire width of the heel segment, thus connecting the entirety of the heel to the sole bed can be used in yet another embodiment, as detailed below.

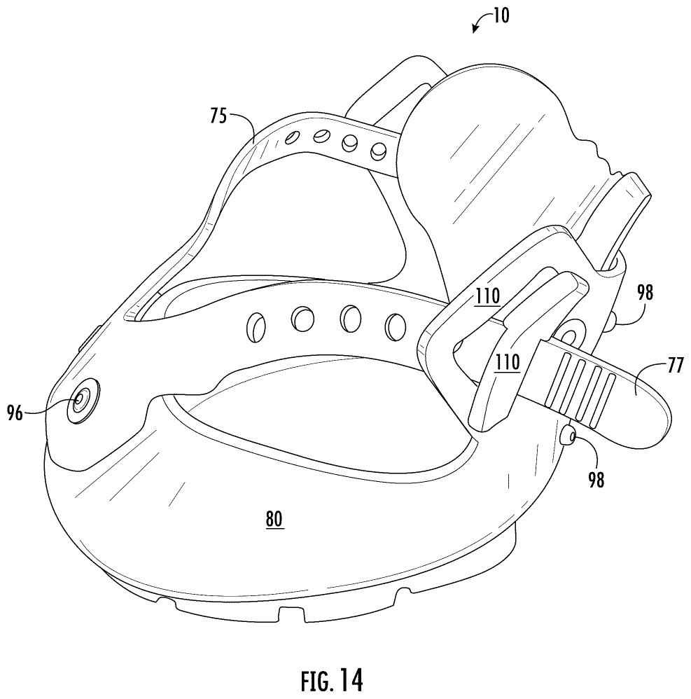

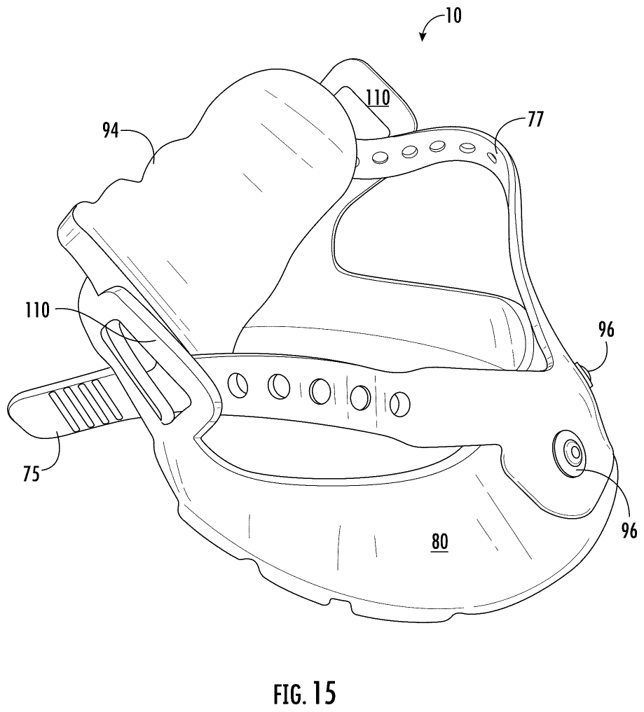

FIGS. 14-15 illustrate an embodiment of the hoof boot having an additional heel support 94 that is connected to heel segment 90 by inserts or pegs 98, which are press fit into fenestrations 120 (shown in FIG. 3). Heel support 94 can be provided with a resilient, soft, synthetic rubber portion in a wing shape that provides the horse with comfortable support. Further, FIGS. 14-15 depict the use of a harness 79 having belts 75 and 77. Belts 75 and 77 can be provided with teeth intended to secure the belt to the frames/heel segment, holes secured by a peg (as detailed below), or a hook and loop securement. Harness 79 is attached to wall 80 with screws 96 or other similar securement devices that will be apparent in light of the present disclosure. Alternatively, harness 79 can be formed as part of part of wall 80. Harness 79 is used to secure the boot onto a horse. In yet another embodiment, an additional support belt or strap can be looped around and removably attached to larger frames 110 shown in FIG. 15.

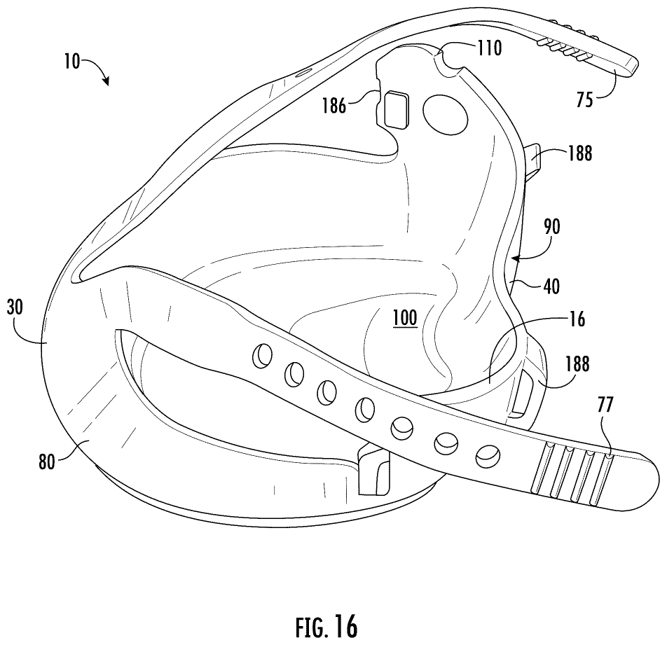

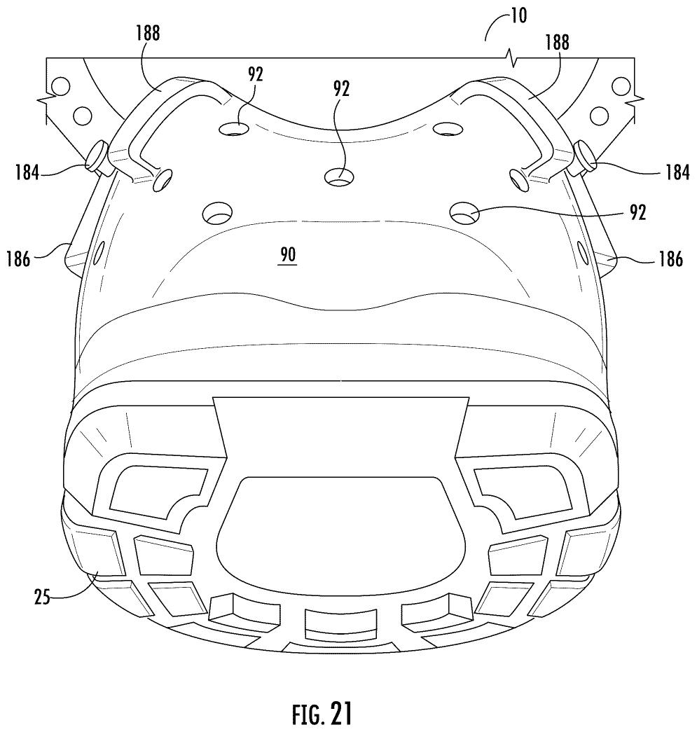

FIGS. 16-30 depict an alternative embodiment of a multi-density horse boot 10. As shown in FIGS. 16-21, horse boot 10 includes an interior shaped to receive removable gaiter 12, which is configured to be securely attached to the pastern region of a horse. Generally, boot 10 is defined by an integrated wall 80 (FIG. 16), belts 75 and 77, sole 25 (FIG. 21), heel segment 90 and belt loops or slides 186 and 188 (FIG. 21), which are overmolded as shown in FIGS. 16-22. In the boot embodiment of FIGS. 16-21, each of the wall, sole, heel and slides have different densities and elastomeric characteristics. In one present embodiment, the sole has a durometer between 80A and 90A; the wall, a durometer between 55A and 70A; the belts, a durometer between 55A and 70A; the belt loops or slides, a durometer between 80A and 90A; and the heel, a durometer between 55A and 70.

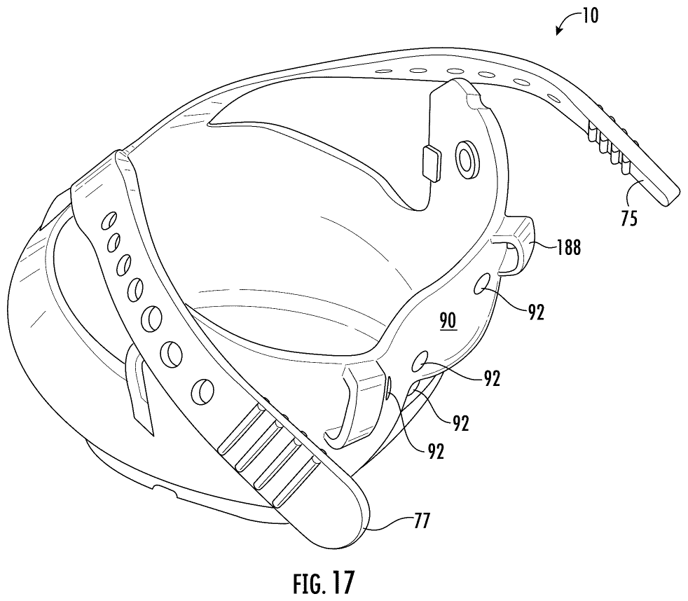

As depicted in FIGS. 17, 19, 20 and 21, heel segment 90 is sized to supportively receive the heel of a horse hoof. Given the sensitivity of a horse's heel, heel segment 90 is formed from a resilient, soft, highly-flexible and elastomeric material that provides flexibility and mobility. Additionally, heel segment 90 is provided with numerous holes 92, which receive and secure gaiter 12 to the hoof boot, as detailed below. Further, heel segment 90 includes distal slide 186, proximal slide 188, and catch 184 which together receive belts 75 and 77 to secure boot 10 to a horse hoof.

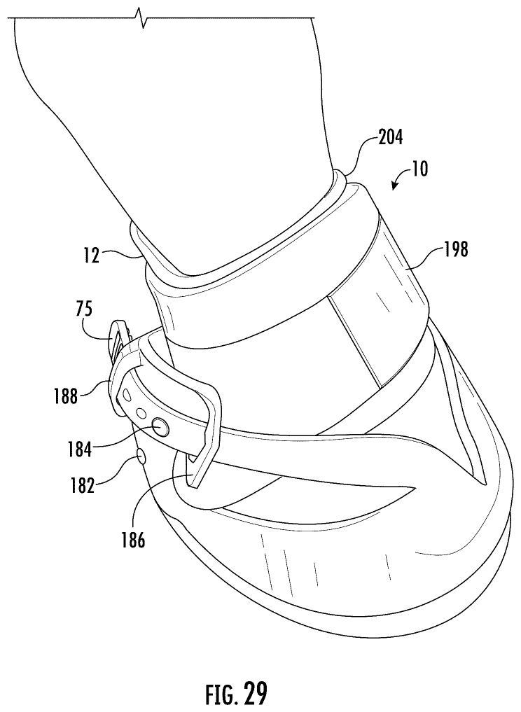

Belts or straps 75 and 77 are welded to wall 80 at weld 72, and project generally from distal end 30 toward proximal end 40 of hoof boot 10. Alternatively, belts or straps 75 and 77 can be incorporated into the mold of wall 80. Belts 75 and 77 each have a working end or tail end. The working ends are configured to be attached or secured to the heel segment through belt loops or slides. Thus, to fit boot 10 to a horse, as shown in FIG. 29, belts or straps 75 and 77 can be inserted through distal slide 186. At a desired size, catch 184 is inserted into a sizing hole 185 in the belt, and the working end or tail end of the belt is received by the respective proximal slide. This facilitates rapid loosening and tightening of the boot during use. Although belts 75 and 77 are elastomeric in one embodiment, they can alternatively be made of a material having a substantially low level of elasticity. In another embodiment, a three slide buckle can be used instead of the catch and slide system.

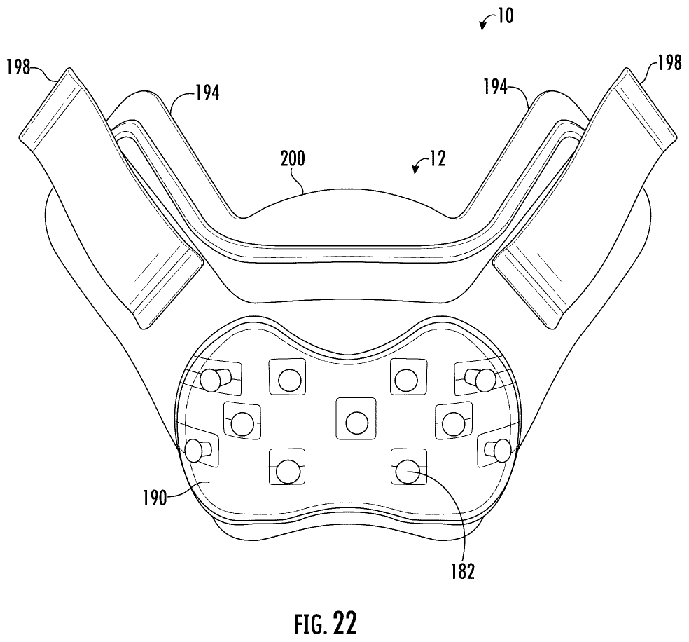

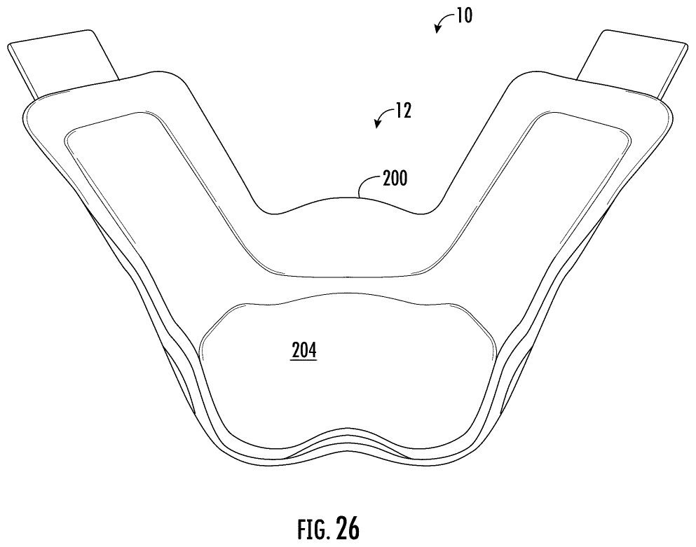

As shown in FIGS. 22-30, boot 10 includes a removable gaiter 12. Removable gaiter 12 includes a wrap 200. Referring to FIG. 26, wrap 200 is made of one or more layers of a resilient, soft, elastomeric material such as a synthetic rubber or neoprene lining 204. Further, as depicted in FIG. 22, wrap 200 includes pastern straps 194. Opposing fasteners 198 are sewn to pastern straps 194. Fasteners 198 can be made of hook and loop fastener material, thereby allowing securement of the wrap around the heel and to the pastern of a horse. When properly secured to a horse, wrap 200 keeps debris or unwanted materials from coming into contact with the hoof parts that are covered by wrap 200, thus protecting the horse's hoof and pastern. Further, removable gaiter 12 can be used as a sacrificial material that can be replaced without replacement of the entire hoof boot.

As shown in FIG. 22, a heel cup fastener 190 is securely sewn to wrap 200. Fastener 190 has a plurality of polymer pegs 182. To connect fastener 190 to shoe 10, pegs 182 are press fit through fenestrations or holes 92. Similarly, fastener 190 can be removed for replacement by simply pulling fastener 190 firmly away from heel segment 90 of boot 10.

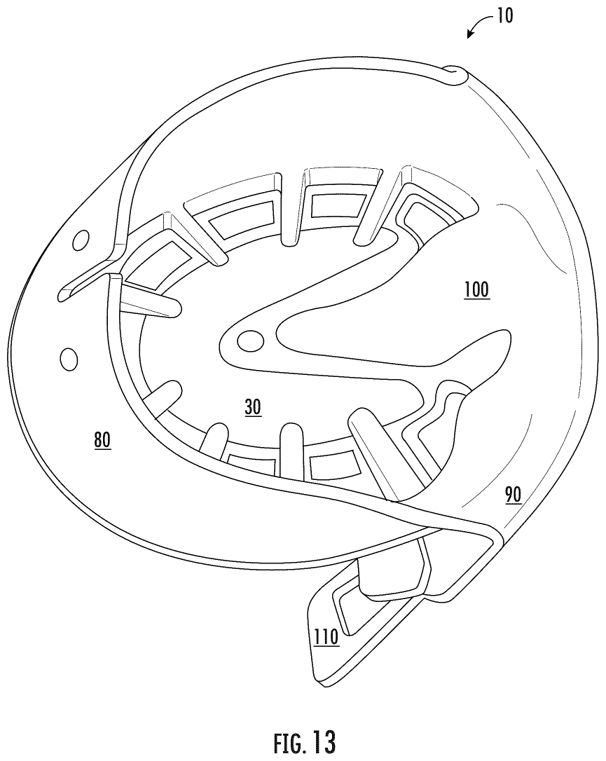

To fit the boots 10 to a particular horse, a user must first size each hoof. This can be accomplished by measuring the width and length of each hoof with a fit-kit, such as supplied by Easycare, Inc. Based on the width and length of each hoof, a boot of a proper size is selected. To facilitate placement of boot 10 on a horse hoof, a user can evert heel segment 90 as illustrated in FIG. 13.

Boot 10 is injection molded using a multi-step overmolding process. In particular, the rigid sole and wall are molded and cured. Subsequently, the resilient components, including the heel segment are molded directly to the wall in the lower transition region 150. Further, frames 110, once molded and cured, are molded onto upper transition region 160 of the heel segment. As the heel segment cools, it is bonded to the wall and the frames to form a single, strong and seamless shoe. The overmolding process can be carried out manually for small production runs or automatically for large production runs. In one manufacturing method, the parts are overmolded using carousel molding. In another manufacturing method, the parts are overmolded using shuttle molding.

This disclosure describes various elements, features, aspects, and advantages of various embodiments and examples and configurations thereof of composite compositions. It is to be understood that certain descriptions of the various embodiments have been simplified to illustrate only those elements, features and aspects that are relevant to a more clear understanding of the disclosed embodiments, while eliminating, for purposes of brevity or clarity, other elements, features and aspects. Any references to “various embodiments,” “certain embodiments,” “some embodiments,” “one example,” “one embodiment,” “an example,” or “an embodiment” generally means that a particular element, feature and/or aspect described in the embodiment is included in at least one embodiment. The phrases “in various embodiments,” “in certain embodiments,” “in some embodiments,” “in one embodiment,” or “in an embodiment” may not refer to the same embodiment.” Furthermore, the phrases “in one such embodiment” or “in certain such embodiments,” or “in one example,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the invention as defined solely by the claims.

What is claimed is:

1. An equine hoof boot, comprising:
a shoe comprising a sole and a wall extending from the sole;
a heel segment overmolded to the wall;
a tongue having a first end and a second end, the first end being overmolded to the heel segment and the second end being overmolded to the sole; and
a plurality of frames overmolded to the heel segment.

2. The equine hoof boot of claim 1, further comprising:
a fenestration disposed through the heel segment; and
a heel support having a peg, the peg being disposed through the fenestration.

3. The equine hoof boot of claim 2, further comprising:
a harness attached to the wall, the harness having a first strap.

4. The equine hoof boot of claim 3, further comprising:
a second strap extending from the harness.

5. The equine hoof boot of claim 2, further comprising a synthetic rubber pad attached to the heel support.

6. The equine hoof boot of claim 4, wherein the shoe is formed from a polymer having a durometer between 80A and 90A, the heel segment is formed from a polymer having a durometer between 55A and 70A, and the tongue is formed from a polymer having a durometer between 55A and 70A.

7. The equine hoof boot of claim 6, wherein the shoe polymer is formed from urethane.

8. The equine hoof boot of claim 7, wherein the heel is formed from urethane.

9. The equine hoof boot of claim 8, wherein the tongue is formed from urethane.

10. The equine hoof boot of claim 1, wherein the shoe is formed from a polymer having a durometer between 80A and 90A.

11. The equine hoof boot of claim 1, wherein the heel segment is formed from a polymer having a durometer between 55A and 70A.

12. The equine hoof boot of claim 1, wherein the tongue is formed from a polymer having a durometer between 55A and 70A.

13. An equine hoof boot, comprising:
a shoe comprising a sole and a wall extending from the sole;
a heel segment overmolded to the wall;
a first belt extending from the wall, the first belt having a working end; and
a second belt extending from the wall, the second belt having a working end, wherein the working end of the first belt and the working end of the second belts are configured to be secured to the heel segment.

14. The equine hoof boot of claim 13, further comprising:
a catch adapted to secure the first belt to the heel segment, and a second catch adapted to secure the second belt to the heel segment.

15. The equine hoof boot of claim 13, further comprising:
a gaiter having a heel cup fastener; and a peg extending from the heel cup fastener;
a fenestration disposed through the heel segment, the peg being removably press fit into the fenestration, thereby securing the heel cup fastener to the heel segment.

16. The equine hoof boot of claim 15, the gaiter further comprising a synthetic rubber pad attached to the heel cup fastener; and a strap attached to the synthetic rubber pad, wherein the strap is configured to secure the gaiter to a pastern of a horse.

17. The equine boot of claim 16, wherein the heel cup fastener forms a first cup and a second cup, wherein the first and second cups are adapted to receive the bulbs of a horse heel.

18. The equine boot of claim 16, wherein the shoe is formed from a polymer having a durometer between 80A and 90A, and the heel segment is formed from a polymer having a durometer between 55A and 70A.

19. The equine hoof boot of claim 18, wherein the shoe polymer is formed from urethane and the heel segment polymer is formed from urethane.

20. An equine hoof boot, comprising:
a sole having a durometer between 80A and 90A, and a wall having a durometer between 80A and 90A;
a heel segment seamlessly attached to the wall and the sole, the heel segment having a durometer between 55A and 70A; and a means for securing the equine hoof boot to the hoof of a horse.

21. An equine hoof boot, comprising:
a shoe comprising a sole and a wall extending from the sole;
a heel segment overmolded to the wall;
a plurality of frames overmolded to the heel segment;
a first belt overmolded to the wall;
a second belt overmolded to the wall, wherein the first and second belts are configured to be secured at one end to the heel segment;
a catch adapted to secure the first belt to the heel segment, and a second catch adapted to secure the second belt to the heel segment;
a gaiter having a heel cup fastener and a synthetic pad attached to the heel cup fastener;
a peg extending from the heel cup fastener; and
a fenestration disposed through the heel segment, the peg being removably press fit into the fenestration, thereby securing the heel cup fastener to the heel segment.
